(19) United States
(12) Patent Application Publication
(10) Pub. No.: US 2024/0185532 A1
(43) Pub. Date: Jun. 6, 2024

(54) AUGMENTED REALITY ENABLED GLASSES FOR SPORTS

(71) Applicant: AMC Corporation, Sammamish, WA (US)

(72) Inventor: Shengwei Da, Saint Cloud, FL (US)

(73) Assignee: AMC Corporation, Sammamish, WA (US)

(21) Appl. No.: 18/517,875

(22) Filed: Nov. 22, 2023

Related U.S. Application Data
(60) Provisional application No. 63/429,957, filed on Dec. 2, 2022.

(51) Int. Cl. G06T 19/00; A63B 24/00; A63B 69/36; G02B 27/01; G06F 3/01

(52) U.S. Cl. CPC G06T 19/00; A63B 24/0003; A63B 69/36; G02B 27/0103; G02B 27/0172; G06F 3/012; G06F 3/013; G06F 3/017

(57) ABSTRACT

One embodiment of this disclosure can provide a pair of augmented reality (AR) glasses. The AR glasses can include a pair of lenses and a frame. At least a portion of a lens of the AR glasses can function as a see-through display, and the frame can be embedded with at least a processing unit, a storage unit, a network unit, and a user-interaction unit.

### RELATED APPLICATIONS

This disclosure claims the benefit of U.S. Provisional Application No. 63/429,957, Attorney Docket No. AMC22-1001PSP, entitled “AUGMENTED REALITY ENABLED GLASSES,” by inventor Shengwei Da, filed 2 Dec. 2022, the disclosure of which is incorporated herein by reference in its entirety for all purposes.

### BACKGROUND

### Field

The disclosed embodiments generally relate to augmented reality (AR) technologies. More specifically, the disclosed embodiments relate to AR-enabled glasses for sports applications.

### Related Art

Wearable devices (also referred to as wearables) have gained popularity in recent years due to their versatility and the ability to integrate cutting-edge technologies seamlessly into daily life. Among the various types of wearable devices, smartglasses have the potential to revolutionize the way humans interact with digital information and their surroundings because they are often placed right in front of users' eyes. Typical smartglasses can use AR technologies to overlay digital information, visuals, and data onto users' real-world view and are often referred to as AR-enabled glasses or simply AR glasses. Although different types of smartglasses (e.g., Google Glass and Microsoft Hololens) have been developed in the past, there still lacks a solution for compact and lightweight smartglasses for sports applications.

### SUMMARY

One embodiment of this disclosure can provide a pair of augmented reality (AR) glasses. The AR glasses can include a pair of lenses and a frame. At least a portion of a lens of the AR glasses can function as a see-through display, and the frame can be embedded with at least a processing unit, a storage unit, a network unit, and a user-interaction unit.

In a variation on this embodiment, the see-through display can include a near-eye geometric-waveguide-based display or a near-eye holographic-waveguide-based display.

In a variation on this embodiment, the see-through display can display multiple windows simultaneously in a 360° space surrounding a user's head.

In a further variation, the see-through display can switch focus among the multiple windows based on the user's head and/or eye movement.

In a variation on this embodiment, the storage unit can include one or more of a random-access memory (RAM) device, a dynamic random-access memory (DRAM) device, and an interface for coupling to an external storage device.

In a variation on this embodiment, the network unit can include one or more of a Wi-Fi communication sub-unit, a cellular communication sub-unit, a Bluetooth communication sub-unit, and an Internet of Things (IoT) communication sub-unit.

In a further variation, the AR glasses can communicate with a golf launch monitor and/or one or more wearable sensors via the Bluetooth communication sub-unit.

In a further variation, the AR glasses can communicate with a remote server via the Wi-F communication sub-unit or the cellular communication sub-unit.

In a variation on this embodiment, the user-interaction unit can include one or more of a head-mouse sub-unit for interacting with a user by tracking head and/or eye movement of the user, a hand-gesture sub-unit for interacting with the user by detecting the user's hand gestures, a voice-control sub-unit for interacting with the user by performing speech-recognition operations, and an external-control sub-unit for interacting with the user using one or more external controllers.

In a variation on this embodiment, the AR glasses can further include a number of sensors embedded in the frame.

In a further variation, the sensors can include one or more of a number of front-facing cameras; a number of rear-facing cameras; a sound sensor; a number of motion sensors; and a Global Positioning System (GPS) sensor.

In a variation on this embodiment, the AR glasses can further include a localization unit to apply simultaneous localization and mapping (SLAM) algorithms to map a near-field environment surrounding the user.

In a variation on this embodiment, the AR glasses can further include a virtual reality (VR) unit to generate one or more virtual objects to be displayed on the see-through display.

In a further variation, the virtual objects can include one or more: environmental information, a virtual golf coach, golf swing recommendations, and golf performance data.

In a variation on this embodiment, the AR glasses can further include a power unit.

One embodiment can provide a computer system that includes a processor and a storage device coupled to the processor. The storage device storing instructions which, when executed by the processor, cause the processor to perform a method for assisting a user in playing golf. The method can include obtaining, by a number of sensors embedded in a pair of augmented reality (AR) glasses worn by the user, environmental information associated with a golf course; displaying, by a see-through display associated with the AR glasses, the environmental information; generating and displaying a game plan for striking a golf ball toward a destination; monitoring simulated golf swings performed by the user; generating and displaying golf swing recommendation; and displaying performance data associated with the user's strike of the golf ball.

### DESCRIPTION OF THE FIGURES

FIG. 1 illustrates an exemplary block diagram of an augmented reality (AR)-glasses system, according to one embodiment of the instant application.

FIG. 2 illustrates an exemplary block diagram of the user-interaction unit, according to one embodiment of the instant application.

FIG. 3 illustrates an exemplary block diagram of the network unit, according to one embodiment of the instant application.

FIG. 4 illustrates an exemplary block diagram of the sensor unit, according to one embodiment of the instant application.

FIG. 5A illustrates an exemplary pair of AR glasses, according to one embodiment of the instant application.

FIG. 5B illustrates an exemplary appearance of a hat with embedded AR glasses, according to one embodiment of the instant application.

FIG. 6 illustrates an exemplary course map displayed by the AR glasses, according to one embodiment of the present invention.

FIG. 7A illustrates an exemplary screenshot of the AR display, according to one embodiment of the instant application.

FIG. 7B illustrates an exemplary swing simulation scenario, according to one embodiment of the instant application.

FIG. 8 presents a flowchart illustrating an exemplary operation process of a pair of AR glasses, according to one embodiment of the instant application.

FIG. 9 illustrates an exemplary computer system that facilitates the operation of the golf AR glasses, according to one embodiment of the instant application.

In the figures, like reference numerals refer to the same figure elements.

### DETAILED DESCRIPTION

### Overview

Embodiments of this disclosure can provide compact and lightweight smartglasses that are designed for sports (e.g., golf) applications. The smartglasses can use transmissive display and holographic 3D projection techniques to display images and data associated with the user's environment and can display multiple windows. The smartglasses can interact with the user by performing six degrees of freedom (6DOF) tracking of head and hand gestures of the user and by natural language processing (NLP)-based speech recognition. The user can switch among multiple windows by changing the field of vision. The smartglasses can include various types of network interfaces to allow it to communicate with the cloud and other nearby devices. The smartglasses can use simultaneous localization and mapping (SLAM) algorithms to determine the near-field environment surrounding the user. Depending on the application, the smartglasses can also interact with other auxiliary devices (e.g., Doppler radar if used for golfing) to obtain and display information associated with the ongoing sports activity of the user.

In this disclosure, the terms “smartglasses,” “AR glasses,” or “AR-enabled glasses” are used interchangeably.

### System Diagram

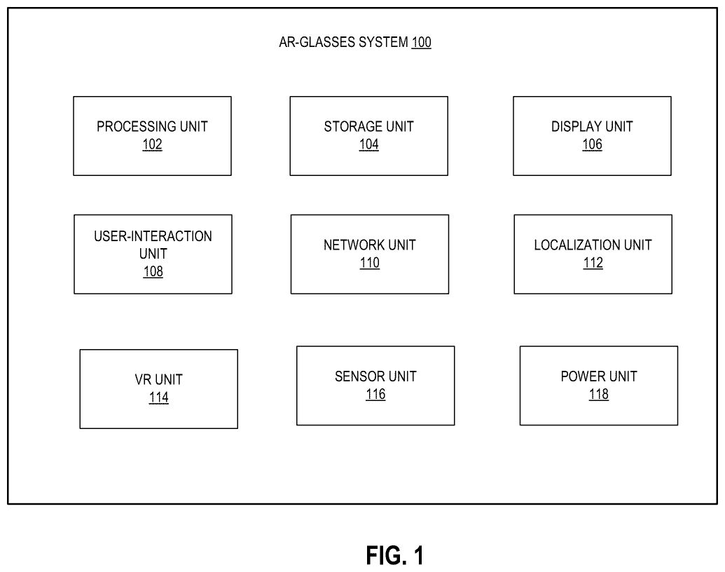

FIG. 1 illustrates an exemplary block diagram of an augmented reality (AR)-glasses system, according to one embodiment of the instant application. AR-glasses system 100 can include a processing unit 102, a storage unit 104, a display unit 106, a user-interaction unit 108, a network unit 110, a localization unit 112, a virtual reality (VR) unit 114, a sensor unit 116, and a power unit 118.

Processing unit 102 can be the brain of AR-glasses system 100 and can include one or more processors for performing various computing tasks. In some embodiments, processing unit 102 can include processors that are optimized for edge computing, which is defined as computing outside the cloud happening at the edge of the network. In one embodiment, processing unit 102 can include a high-speed multi-core processor (e.g., SDM 660 developed by Qualcomm).

Storage unit 104 can include a memory, a solid-state storage device, or both. The memory in storage unit 104 can include random-access memory (RAM) device, dynamic random-access memory (DRAM) device, or both. In one embodiment, storage unit 104 can include a RAM device with a capacity of at least 2 GB and a DRAM device with a capacity of at least 64 GB. In addition to onboard storage capacity, storage unit 104 can also include a storage extension slot for plugging in an external storage device (e.g., a Secure Digital (SD) card or a microSD card). In one example, the capacity of the external storage device can be at least 256 GB. Storage unit 104 can store an operating system, which can be executed by the processor(s) in processing unit 102 to provide a number of functions, including collecting various types of input information, processing the input information, and displaying the corresponding output information. In one example, the operating system can be a mobile operating system such as Android.

Display unit 106 can include one or more transmissive displays. In some embodiments, the transmissive displays can be see-through displays and can include one or both lenses of the AR glasses. In further embodiments, each see-through display may include the entire lens or a portion of a lens. The displays can be substantially transparent to allow the user wearing the glasses to view the displayed information along with the surrounding environment. In some embodiments, display unit 106 can use near-eye display technology to display information (e.g., data and graphics) in such a way that the user can perceive the information as being projected at a distance between two and three meters and with a viewing angle of approximately 110 degrees. The resolution of the display can be at least 2K (e.g., 2048×1080 pixels), and the frame rate can be at least frames per second (FPS).

In some embodiments, a see-through display can include a geometrical or arrayed waveguide display, which can use arrayed waveguides to expand or enlarge high-resolution images provided by a microdisplay. In one embodiment, the geometrical waveguide display can include more than one (e.g., two) waveguide layers. When both lenses are used as displays, stereo images can be generated by displaying a slightly different image on each lens to be viewed by each eye. In alternative embodiments, a see-through display can include a holographic waveguide display, where the lenses are made of nano-scale holograms. In some embodiments, the holographic waveguide display in display unit 106 can create 360° holographic 3D images.

In some embodiments, display unit 106 can implement unlimited virtual screen extension, where the region of display can be controlled based on changes in the field of vision (or visual field) of the user. For example, when the user's field of vision changes as the user turns the head or looks away, display unit 106 can change the region of display accordingly such that the region of display can be in the center of the user's field of vision. In one example, display unit 106 can display multiple windows simultaneously in the 360° space surrounding the user's head and can switch between the windows based on the head movement of the user. Alternatively, the user may use hand gestures or a physical controller to switch between the windows.

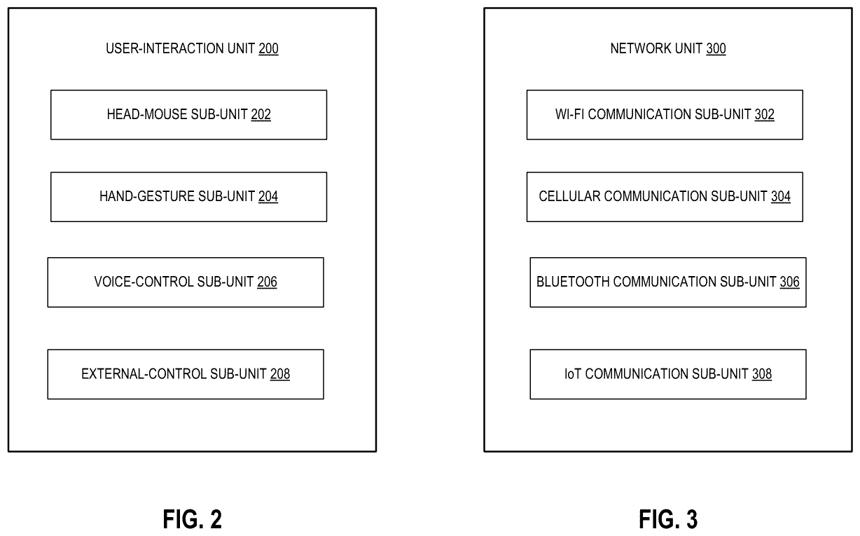

User-interaction unit 108 can include various sub-units for interacting with the user using various user-interaction mechanisms, including but not limited to head/eye or hand gesture tracking, speech recognition, and usage of external controllers. FIG. 2 illustrates an exemplary block diagram of the user-interaction unit, according to one embodiment of the instant application. In FIG. 2, user interaction unit 200 can include a head-mouse sub-unit 202, a hand-gesture sub-unit 204, a voice-control sub-unit 206, and an external-control sub-unit 208.

Head-mouse sub-unit 202 can track the movement of a user's head and translate such movement into mouse pointer movement. For example, the mouse pointer may follow the movement of the head. Move your head to the right, the mouse pointer moves to the right as well. A quick nod can be translated into a mouse clicking. In one embodiment, head-mouse sub-unit 202 may interface with a motion sensor (e.g., an accelerometer) embedded in the frame of the AR glasses to detect the head movement. In an alternative embodiment, head-mouse sub-unit 202 may detect the head movement based on images captured by a camera. In further embodiments, head-mouse sub-unit 202 can also track the movement of the user's eyes to control the mouse pointer. In this example, the user's eye movement (e.g., left and right or up and down) can be translated to the mouse pointer movement.

Hand-gesture sub-unit 204 can track and translate the hand gestures of the user into mouse pointer operations. In some embodiments, hand-gesture sub-unit 204 can detect the user's hand and recognize a number of predetermined hand gestures (such as closed fist, open fist, waving, etc.) based on live images. Each hand gesture can be mapped to a mouse operation. For example, a closed fist gesture may indicate confirming a selection (which can be equivalent to a mouse click), an open fist gesture may indicate closing a window, and a waving gesture may indicate turning the page. Hand-gesture sub-unit 204 can also track the movement of the hand (e.g., from left to right or from right to left) and move the mouse according to the hand movement.

Voice-control sub-unit 206 can facilitate the voice-based interactions between the user and the AR glasses. In some embodiments, voice-control sub-unit 206 can implement machine-learning techniques (e.g., Natural Language Processing (NLP) models) to translate the user's speech into operational commands. For example, after detecting the user's speech, voice-control sub-unit 206 can first use a speech recognition technique to process the speech into a written format (e.g., text) and then perform semantic analysis (e.g., by applying an NLP model) on the speech to obtain an operational command.

External-control sub-unit 206 can receive user inputs from various external user-control devices (e.g., an external mouse, a 6DOF joystick, a button, a touch sensor, etc.). The user can interact with an external device, which can then relay the user commands to the AR glasses.

In the example shown in FIG. 2, user-interaction unit 200 includes the aforementioned four sub-units. In practice, the AR glasses can use any mechanism to interact with the user, and user-interaction unit 200 can include any number of sub-units, including but not limited to those shown in FIG. 2.

Returning to FIG. 1, network unit 110 can be responsible for facilitating communications between AR-glasses system 100 and the network (e.g., the cloud). Network unit 110 can include a number of sub-units for establishing different types of communication channels. FIG. 3 illustrates an exemplary block diagram of the network unit, according to one embodiment of the instant application. In FIG. 3, network unit 300 can include a Wi-Fi communication sub-unit 302, a cellular communication sub-unit 304, a Bluetooth-communication sub-unit 306, and an IoT communication device 308.

Wi-Fi communication sub-unit 302 can be responsible for establishing a wireless communication channel based on various Wi-Fi protocols, such as the IEEE 802.11 standard. For example, Wi-Fi communication sub-unit 302 can include a radio that can communicate with a nearby Wi-Fi access point or hotspot. Cellular communication sub-unit 304 can establish a wireless communication channel based on various cellular mobile network standards, such as long-term evolution (LTE), 4G, 5G, etc. In one example, cellular communication sub-unit 304 can include a cellular modem to couple the AR glasses to a cellular network. Note that both the Wi-Fi communication sub-unit 302 and the cellular communication sub-unit 304 can allow the AR glasses to communicate with the cloud. This cloud networking capability allows the AR glasses to offload some computing (especially those requiring lots of resources) to the cloud while performing other computing locally. For example, when used for playing golf, the AR glasses can use Wi-Fi communication sub-unit 302 or cellular communication sub-unit 304 to download course-specific information such as terrain, real-time weather, and wind information from the cloud.

In addition to communicating with the cloud, the AR glasses can also communicate with a nearby device via Bluetooth communication sub-unit 306 or Internet of Things (IoT) communication sub-unit 308. Bluetooth communication sub-unit 306 can include a Bluetooth transmitter and a Bluetooth receiver for interacting with other Bluetooth-enabled devices, such as a smartphone, ear pods, or various monitoring devices. For example, when the AR glasses are used for playing golf, Bluetooth communication sub-unit 306 can communicate with a golf launch monitor (e.g., a Doppler radar-based launch monitor) to obtain club and ball data (e.g., launch angle, ball speed, etc.). IoT communication sub-unit 308 can allow AR glasses to communicate with IoT devices according to various IoT communication standards (e.g., Zigbee). For example, when the AR glasses are used for playing golf, IoT communication sub-unit 308 can communicate with wearable sensors (e.g., a motion sensor embedded in the user's glove) to obtain performance data associated with the user's swing. The wearable sensors may also be embedded in a bracelet or ring worn by the user. Depending on the sensor type, the AR glasses can also communicate with the wearable sensors via Bluetooth communication sub-unit 306.

Returning to FIG. 1, localization unit 112 can be responsible for determining the near-field environment of the user. In one embodiment, localization unit 112 can apply a simultaneous localization and mapping (SLAM) technique to determine its location and the surrounding environment. For example, localization unit 112 can use a 3D scanning technique (e.g., through a laser scanner or an infrared matrix scanner) to map out the terrain surrounding the user. This location information can be used by the AR glasses to recognize and track objects (e.g., people, flags) in the environment and to accurately map the user's near-field environment. The location information can also be used to generate information about the user's surroundings (such as slope, water hazard, sand pit, etc.) and superimpose such information on the real-world objects in the user's view. The location information can also be used to place virtual objects (e.g., a virtual coach or a virtual obstacle) in appropriate locations within the user's view to create a mixed reality (MR), in which the user can interact with both the physical world and the virtual world.

VR unit 114 can be responsible for generating virtual objects and determining the location for placing a virtual object in the real-world scene. Depending on the use scenario, VR unit 114 can generate different types of virtual objects. For example, VR unit 114 can render images comprising virtual objects to be displayed on the see-through display. Some virtual objects can include information (e.g., annotations) about the user's environment. For example, if the user is on a golf course, the virtual objects can include weather information (e.g., temperature, humidity, wind direction/speed, etc.) as well as course information (e.g., course map). Some virtual objects can include computer-generated human characters or objects (e.g., a virtual coach, a virtual sand pit, etc.). VR unit 114 can use the location information provided by localization unit 112 to place the virtual objects at appropriate locations within the user's view. In one example, the virtual object can be an entire golf course such that a user can have the virtual experience of playing golf at any location (e.g., in a living room). VR unit 114 can also facilitate the interactions between the user and the virtual objects. In one example, the user can manipulate virtual objects using hand gestures or head movements.

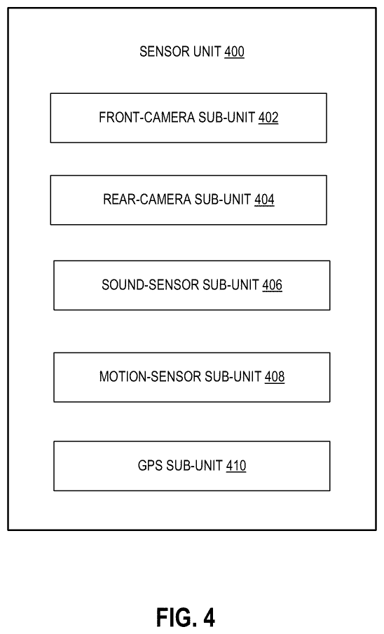

Sensor unit 116 can include different types of sensors that facilitate the various operations of the AR glasses. FIG. 4 illustrates an exemplary block diagram of the sensor unit, according to one embodiment of the instant application. Sensor unit 400 can include a front-camera sub-unit 402, a rear-camera sub-unit 404, a sound-sensor sub-unit 406, a motion-sensor sub-unit 408, and a Global Positioning System (GPS) unit 410.

Front-camera sub-unit 402 can include one or more front-facing cameras that can capture images of the environment while the user is wearing the AR glasses. Such images can be used to obtain environmental information as well as certain user information. For example, the front-facing cameras can capture images of the user's hand to allow for hand-gesture-based control. Moreover, images captured by the front-facing cameras can be streamed in real-time to allow the user to live stream engaged sports activity, such as playing golf, to online viewers. In some embodiments, front-camera sub-unit 402 can also include one or more time-of-flight (ToF) cameras that can be used to measure the distances of objects in the surrounding environment. Rear-camera sub-unit 404 can include one or more rear-facing cameras that can be used to track the movement of the user's eyes. In one embodiment, the front- and/or rear-facing cameras can include complementary metal-oxide semiconductor (CMOS) sensors. In alternative embodiments, the AR glasses may also include cameras facing the side to collect image information surrounding the user.

Sound-sensor sub-unit 406 can include one or more sound sensors for detecting sound signals (e.g., the user's voice). Motion-sensor sub-unit 408 can include a number of sensors used to measure motion, such as an accelerometer, a gyroscope, a magnetometer, etc. In some embodiments, motion-sensor sub-unit 408 can be used to measure or track the user's head movement. GPS unit 410 can receive GPS signals to track the user's geographic location. In addition to the sensors shown in FIG. 4, sensor unit 400 can also include other types of sensors, such as a gravimeter, a geomagnetic sensor, a hexagonal gyroscope, an anemometer, a thermometer, a barometer, etc.

Returning to FIG. 1, power unit 118 can be responsible for providing power to the various units within AR-glasses system 100. In some embodiments, power unit 116 can include a built-in battery and a charging port. In one embodiment, the built-in battery can be a high-density lithium-ion battery with a capacity of greater than 100 mAh. In a further embodiment, the capacity of the battery can be 5000 mAh. The high-capacity battery and the low energy consumption of the various units in the AR glasses can ensure that the AR glasses can operate continuously for a prolonged period (e.g., three or more hours). The charging port can support fast charging. In one embodiment, the charging port can include contact points to allow the battery to be charged when placed in a case. In an alternative embodiment, the charging port can include a wireless charging interface. Power unit 116 can also include an interface for coupling to an external battery, such as a magnetic battery.

### The Appearance

The appearance of the AR glasses may be similar to that of regular glasses or sunglasses. Like a pair of glasses or sunglasses, a pair of AR glasses can include a frame and a pair of lenses. The lenses can be made of glass or plastic and can include a geometric waveguide display or a holographic waveguide display. The frame can be made of acrylonitrile butadiene styrene (ABS) resin or an alloy comprising polycarbonate (PC) and ABS. The electronic components (e.g., the processing, storage, and network units shown in FIG. 1) can be embedded inside the frame. Because the electronic components are lightweight and compact in size, the proposed AR glasses can be lightweight and compact. In some embodiments, the total weight of the AR glasses can be less than 75 grams.

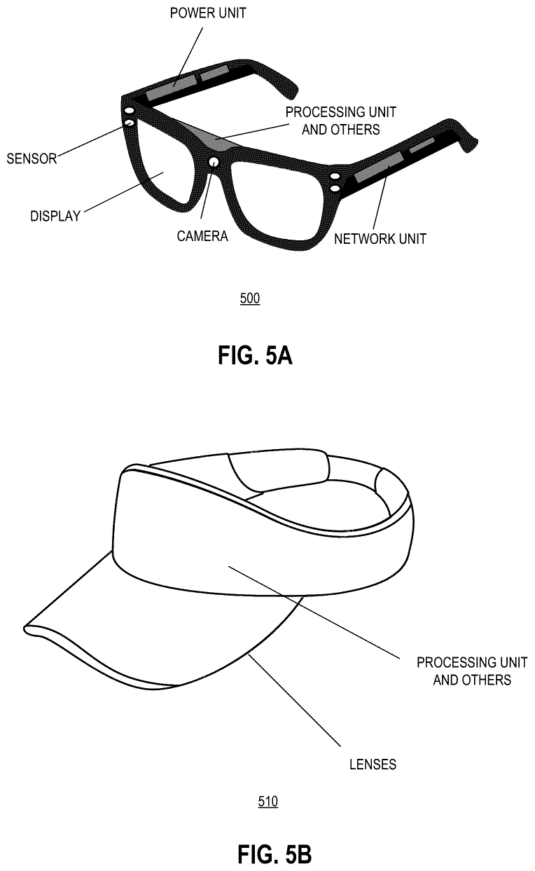

FIG. 5A illustrates an exemplary pair of AR glasses, according to one embodiment of the instant application. FIG. 5A shows that at least one lens of AR glasses 500 can be used as a display, and the rims surrounding the lenses can be embedded with a number of sensors. FIG. 5A also shows that a front-facing camera can be located at the bridge between the two lenses. Amid privacy concerns, the front-facing camera can be equipped with a lens cover that covers the front-facing camera when the user is not recording or streaming. In one embodiment, the front-facing camera can also include an LED indicator that flashes when the camera is in operation to notify surrounding people that recording is taking place.

FIG. 5A also shows that the temples or arms of the frame can include regions for embedding various electronic components, such as the network unit and the power unit. The upper rims of the AR glasses can also be slightly thicker (e.g., with a ledge for a snug fit with the user's forehead) and can be embedded with the processing unit as well as other components. Note that the placement of the different components shown in FIG. 5A is exemplary; depending on the design, different arrangements of the components may also be possible.

In addition to embedding the electronic components into the frame of a pair of glasses, it is also possible to integrate the AR glasses with other types of wearable devices. In some embodiments, the AR glasses can be part of a golf hat or visor, with the lenses (i.e., displays) attached to the brim of the hat or visor. FIG. 5B illustrates an exemplary golf hat with embedded AR glasses, according to one embodiment of the instant application. FIG. 5B shows that the various electronic components (e.g., the processing, storage, and network units shown in FIG. 1) can be embedded in the body of a hat 510, and the lenses can be attached to (may also be foldable) the brim of the hat. In one example, not all but only the bulky electronic components (e.g., the battery) are embedded in the body of the hat.

### The Applications

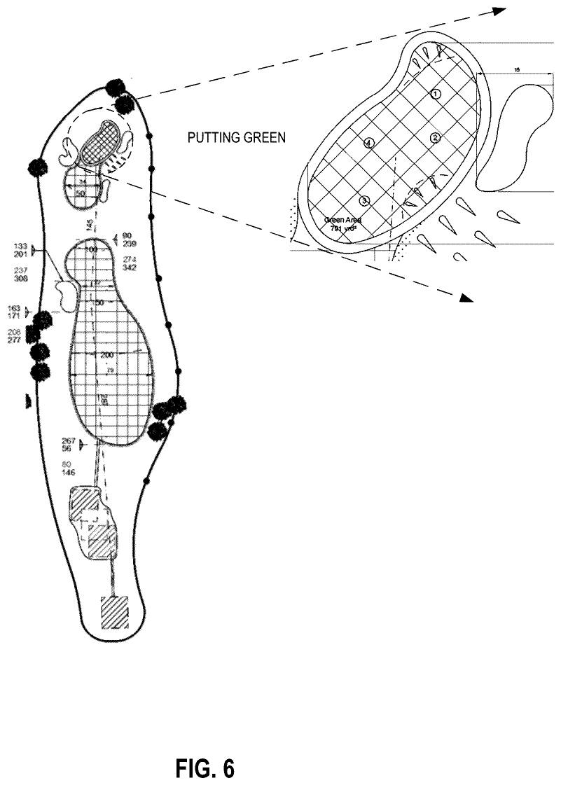

The AR glasses can support many different types of applications. The lightweight and compactness of the proposed AR glasses can make them a good candidate for sport-specific applications. In some embodiments, the AR glasses can support an application for playing golf. The processor in the AR glasses can run the golf application to allow a user wearing the AR glasses on a golf course to view the course information on the see-through display. In some embodiments, a server system for the golf application can store the maps of many known golf courses, including more than 41000 golf courses from over 130 countries and regions. When the user arrives at a golf course, the GPS unit in the AR glasses can obtain the user's location information, and the network unit in the AR glasses can communicate with the server system to download a corresponding course map. The display unit can then display a detailed course map to show locations of the fairway, rough terrain, tee-off positions, sand bunker, water hazard, green, and hole. FIG. 6 illustrates an exemplary course map displayed by the AR glasses, according to one embodiment of the present invention. The user can also zoom in on an area of interest (e.g., the putting green). Note that the displayed map can be updated dynamically based on current conditions. For example, the course map may indicate the locations of the flags, which may change from day to day.

In addition to the course map, the localization unit in the AR glasses can also accurately map the user's surroundings and determine the user's location within the course. For example, the localization unit (together with a ToF camera) can be used to measure the distance between the user and a target (e.g., a golf hole) and determine obstacles (e.g., sand bunkers or water hazards). In some embodiments, the processing unit in the AR glasses can execute instructions to generate a game plan for striking the golf ball based on the distance between the user and the hole and the locations of the obstacles. In one example, the game plan can include suggested shot angle, swing strength, and club choice. The game plan can also be displayed to the user by the display unit in the AR glasses.

In addition to the course map and game plan, the AR glasses can also display live environmental data, including but not limited to the temperature, the humidity, the atmosphere pressure, and the wind speed. The environmental data can be obtained from the various sensors on the AR glasses or from a coupled device (e.g., a smartphone may obtain such data via a weather application and relay such data to the AR glasses).

The AR glasses can operate in two modes: a practice mode and a game mode. When the user is practicing golfing (e.g., at a golf course or a driving range), the AR glasses can be configured to operate in practice mode. While in the practice mode, each time the user swings the golf club to strike a ball, the AR glasses can obtain information about the user's swing and the movement of the ball (e.g., the shot angle, swing speed, smash factor or efficiency, carry distance, spin rate, ball speed, flight height, flight time, etc.) by communicating with an external launch monitor (e.g., a Doppler radar-based launch monitor). Alternatively, the ToF cameras on the AR glasses and the motion sensors worn by the user (e.g., sensors embedded in the user's glove/bracelet/ring) can be used to measure the distance, speed, and angle of the club and the ball and the club grip position. The display unit of the AR glasses can then display the stroke information to the user. In some embodiments, the display unit can also display suggestions to help the user to improve performance. For example, the AR glasses can analyze the user's ball-striking posture and provide posture-improvement or correction suggestions.

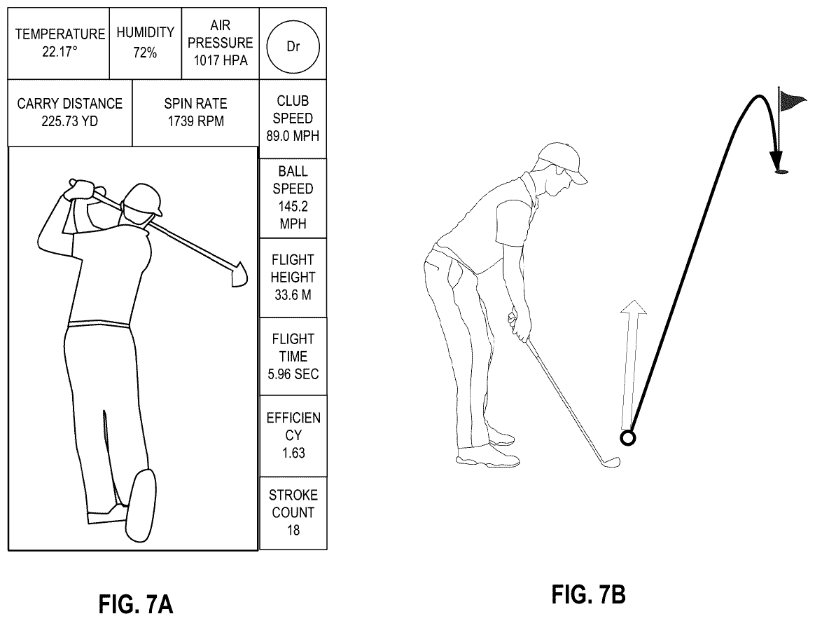

FIG. 7A illustrates an exemplary screenshot of the AR display, according to one embodiment of the instant application. As shown in FIG. 7A, the displayed environmental information can include temperature, humidity, and air pressure. The displayed stroke information can include carry distance, spin rate, club speed, ball speed, flight height and time of the ball, efficiency (which is the ratio between the ball speed and the club speed), and stroke count. Depending on the practical scenario, other types of environmental information (e.g., wind direction and speed, altitude, etc.) and stroke information (e.g., shot angle) may also be displayed.

In some embodiments, the VR unit in the AR glasses can generate a virtual character to be displayed in the scene to guide the user. The virtual character can be a virtual guide that guides the user through the golf course (e.g., showing the user how to travel from one hole to the next or the locations of facilities on the course). The virtual character can also be a virtual coach that can demonstrate to the user the correct way to swing the club. In one embodiment, the VR unit can overlay the virtual coach's club on the user's club in the AR scene to show the deviance between the user's swing and the correct swing.

In some embodiments, the AR glasses can provide a swing simulation function. More specifically, based on the distance between the user and a target and the environmental factors (e.g., the wind speed), the processing unit on the AR glasses can execute instructions to estimate the path of the ball to the target and suggest a swing path (i.e., the path of the club) to the user. VR unit can generate virtual objects representing the estimated ball path and swing path. FIG. 7B illustrates an exemplary swing simulation scenario, according to one embodiment of the instant application. More specifically, the hollow arrow in FIG. 7B shows the swing path, and the solid arrow shows the ball path.

The user can practice the swing before actually striking the ball. For each practice swing, the ToF cameras on the AR glasses and the motion sensors attached to the user's hand or club can provide movement information about the club, such as the swing angle, force, and speed. The VR unit can further generate one or more virtual objects to represent the user's practice swing, including an indicator (e.g., an arrow) of the swing path and an indicator of the simulated ball path or ball landing location. The user can compare the swing path of the practice swing with the suggested swing path. The display of the AR glasses can further display suggested swing corrections, including the swing angle correction, the swing posture correction, and the swing strength correction. The user can simulate the swing multiple times until the simulated swing path can be similar to the suggested swing path before actually striking the ball.

The swing simulation function can also allow the user to practice golfing without going to a golf course or driving range. In some embodiments, by wearing a pair of AR glasses that display a VR view on its display, a user can practice golfing in his living room. More specifically, the VR unit can generate a virtual scene comprising a golf course, which can be displayed to the user by the see-through display of the AR glasses. The user can swing a real golf club while wearing the AR glasses. The movement of the golf club can be captured by the AR glasses (e.g., via the ToF cameras and wearable sensors) and used to compute the movement of a virtual golf ball. The trajectory of the virtual golf ball can be displayed in the VR scene, providing the user with the perception of striking a real golf ball on a real golf course.

When the user is participating in a game of golf (either professionally or for fun), the AR glasses can be configured to operate in game mode. When operating in the game mode, the AR glasses can plan the ball path based on the course map and weather factors, remind the player of locations of hazards (e.g., sand bunkers or water hazards), recommend club choice and swing path to the player, and record stroke count. When operating in the game mode, the AR glasses can also enable the swing simulation function to allow the player to simulate the swings before actually striking the ball. Based on the swing simulation, the AR glasses can provide and display swing correction recommendations to suggest how to correct the swings (e.g., the angle, speed, strength, or body posture).

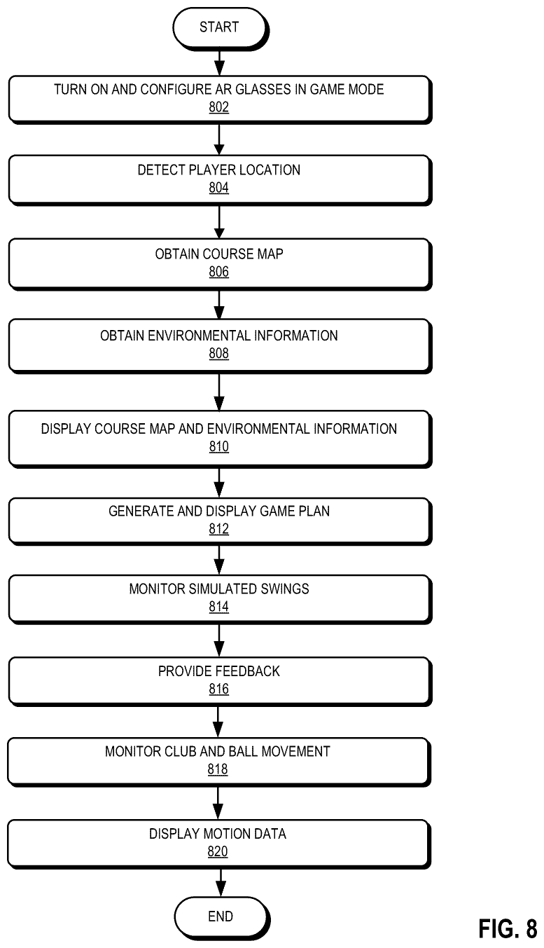

FIG. 8 presents a flowchart illustrating an exemplary operation process of a pair of AR glasses, according to one embodiment of the instant application. In this example, the pair of AR glasses is used to help a player improve performance during a golf game. During operation, the AR glasses can be turned on and configured to operate in game mode (operation 802). The AR glasses can detect, via GPS and 3D-scanning techniques, the location of the player (operation 804). Based on the detected user location, the AR glasses can obtain a course map (operation 806). The course map can show the distance to the hole as well as the locations of the hazards (e.g., sand bunkers or water hazards). The AR glasses can also determine the location of the current target hole based on the course map and the player's location. For example, the user may be in the teeing area or in the middle of the fairway of a particular hole.

The AR glasses can obtain various types of environmental information (e.g., wind direction/speed, temperature, humidity, etc.) (operation 808). The environmental information can be obtained from sensors installed in the AR glasses or by communicating with a coupled device (e.g., a smartphone). The AR glasses can display the course map and the environmental information to the player (operation 810).

The AR glasses can generate and display a game plan (operation 812). In some embodiments, the game plan can be generated based on the course map, the environmental information, the player's current location, and/or the player's ability. In one example, the AR glasses may determine the player's ability (e.g., how far the player can strike the ball) based on historical data. The game plan can include club and swing angle recommendations. The game plan can also include hazard notifications (i.e., notifying the player of locations of nearby hazards).

The AR glasses can then monitor the player's simulated swings (operation 814). Before actually striking the ball, the player can simulate the swing (i.e., swing the club without striking the ball) recommended by the AR glasses, and various monitoring mechanisms (including ToF cameras on the AR glasses, wearable motion sensors, and an external camera- or radar-based launch monitor) can work together to obtain motion data associated with the player's simulated swing, including but not limited to the swing angle, the club speed, the player's body posture, etc. The AR glasses can then analyze the motion data and provide real-time feedback to the player (operation 816). The feedback can include suggested swing corrections. For example, the AR glasses can display a simulated ball path based on the player's simulated swing. Alternatively, the AR glasses can compare the monitored swing simulation with the recommended swing and display the difference (e.g., the deviance in the swing angle and club speed, etc.) to the player, such that the player can simulate the swing again to match the recommended swing. In one example, the recommended swing can be displayed using a vector, with its magnitude indicating the club speed and its direction indicating the swing angle.

When the player performs the actual swing (i.e., striking the ball with the club), the various monitoring mechanisms associated with the AR glasses can monitor the movement of the club and ball (operation 818) and display the motion data associated with the club and ball to the player (operation 820). For example, the AR glasses can communicate with an external radar-based launch monitor to obtain launch data such as the carry distance, the spin rate, the ball speed, the club speed, the flight time and height, and the efficiency. The display unit of the AR glasses can display such information to the player. In addition, the AR glasses can keep track of the number of strokes the player made for each hole and display the stroke count to the player.

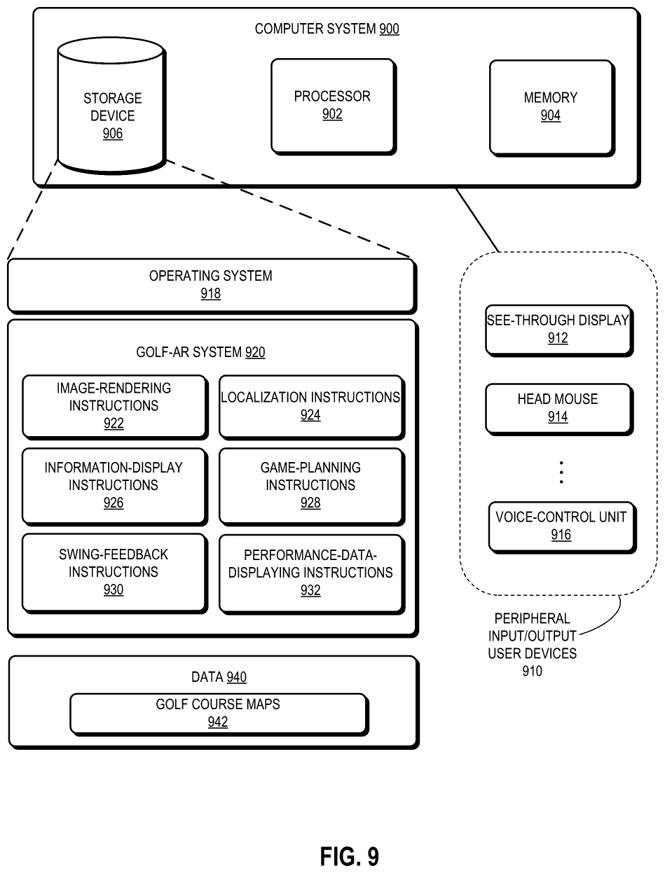

FIG. 9 illustrates an exemplary computer system that facilitates the operation of the golf AR glasses, according to one embodiment of the instant application. Computer system 900 includes a processor 902, a memory 904, and a storage device 906. Furthermore, computer system 900 can be coupled to peripheral input/output (I/O) user devices 910, e.g., a see-through display 912, a head mouse 914, and a voice-control unit 916. Storage device 906 can store an operating system 918, a golf-AR system 920, and data 940.

Golf-AR system 920 can include instructions, which when executed by computer system 900, can cause computer system 900 or processor 902 to perform methods and/or processes described in this disclosure. Specifically, golf-AR system 920 can include instructions for rendering images that include virtual objects (image-rendering instructions 922), instructions for determining the user's location and mapping the surrounding terrains (localization instructions 924), instructions for obtaining and displaying information associated with the location and the surrounding environment (information-display instructions 926), instructions for generating and displaying a game plan (game-planning instructions 928), instructions for providing real-time feedback regarding the simulated swing (swing-feedback instructions 930), and instructions for obtaining and displaying the performance data associated with the user's strike on the ball (performance-data-displaying instructions 932). Data 940 can include golf course maps 942.

This disclosure describes lightweight and compact AR glasses that can be worn by users while performing sports activities such as golfing to enhance experiences and improve performance. The AR glasses can be similar to regular glasses or sunglasses or can be incorporated into a golf hat or visor. One or both lenses of the AR glasses can function as a see-through display with 360° unlimited virtual window extension. The AR glasses can use a number of ways to interact with the user, including head/eye tracking, hand gesture tracking, voice recognition, and the use of external controllers. The AR glasses can include one or more network interfaces (e.g., Wi-Fi, cellular, Bluetooth, IoT) for communicating with servers in the cloud and nearby devices. The AR glasses can also include a number of sensors for obtaining information associated with the user and the environment. More specifically, the AR glasses can include both front- and rear-facing cameras, sound sensors, motion sensors, a GPS sensor, etc. The AP glasses can support sport-specific applications, including a golf application. When running the golf application, the AR glasses may operate in a practice mode or a game mode. When operating in practice mode, the AR glasses can monitor the user's swings and provide recommendations on ways to improve performance. When operating in game mode, the AR glasses can generate and display a game plan that includes swing recommendations. For example, the VR unit in the AR glasses can generate and display virtual objects that represent the golf swing representations (e.g., an arrow indicating the swing angle and strength). The AR glasses can also monitor the user's swing simulations to provide real-time feedback. The AR glasses can also display the user's performance data after each ball strike.

Data structures and program code described in this detailed description are typically stored on a non-transitory computer-readable storage medium, which may be any device or medium that can store code and/or data for use by a computer system. Non-transitory computer-readable storage media include, but are not limited to, volatile memory; non-volatile memory; electrical, magnetic, and optical storage devices, solid-state drives, and/or other non-transitory computer-readable media now known or later developed.

Methods and processes described in the detailed description can be embodied as code and/or data, which may be stored in a non-transitory computer-readable storage medium as described above. When a processor or computer system reads and executes the code and manipulates the data stored on the medium, the processor or computer system performs the methods and processes embodied as code and data structures and stored within the medium.

Furthermore, the optimized parameters from the methods and processes may be programmed into hardware modules such as, but not limited to, application-specific integrated circuit (ASIC) chips, field-programmable gate arrays (FPGAs), and other programmable-logic devices now known or hereafter developed. When such a hardware module is activated, it performs the methods and processes included within the module.

The foregoing embodiments have been presented for purposes of illustration and description only. They are not intended to be exhaustive or to limit this disclosure to the forms disclosed. Accordingly, many modifications and variations will be apparent to practitioners skilled in the art. The scope is defined by the appended claims, not the preceding disclosure.

What is claimed is:

1. A pair of augmented reality (AR) glasses, comprising:
a pair of lenses; and
a frame;
wherein at least a portion of a lens of the AR glasses functions as a see-through display; and
wherein the frame is embedded with at least a processing unit, a storage unit, a network unit, and a user-interaction unit.

2. The AR glasses of claim 1, wherein the see-through display comprises a near-eye geometric-waveguide-based display or a near-eye holographic-waveguide-based display.

3. The AR glasses of claim 1, wherein the see-through display is to display multiple windows simultaneously in a 360° space surrounding a user's head.

4. The AR glasses of claim 3, wherein the see-through display is to switch focus among the multiple windows based on the user's head and/or eye movement.

5. The AR glasses of claim 1, wherein the storage unit includes one or more of: a random-access memory (RAM) device, a dynamic random-access memory (DRAM) device, and an interface for coupling to an external storage device.

6. The AR glasses of claim 1, wherein the network unit comprises one or more of:
a Wi-Fi communication sub-unit;
a cellular communication sub-unit;
a Bluetooth communication sub-unit; and
an Internet of Things (IoT) communication sub-unit.

7. The AR glasses of claim 6, wherein the AR glasses are to communicate with a golf launch monitor and/or one or more wearable sensors via the Bluetooth communication sub-unit.

8. The AR glasses of claim 6, wherein the AR glasses are to communicate with a remote server via the Wi-F communication sub-unit or the cellular communication sub-unit.

9. The AR glasses of claim 1, wherein the user-interaction unit comprises one or more of:
a head-mouse sub-unit for interacting with a user by tracking head and/or eye movement of the user;
a hand-gesture sub-unit for interacting with the user by detecting the user's hand gestures;
a voice-control sub-unit for interacting with the user by performing speech-recognition operations; and
an external-control sub-unit for interacting with the user using one or more external controllers.

10. The AR glasses of claim 1, further comprising a number of sensors embedded in the frame.

11. The AR glasses of claim 10, wherein the sensors comprise one or more of:
a number of front-facing cameras;
a number of rear-facing cameras;
a sound sensor;
a number of motion sensors; and
a Global Positioning System (GPS) sensor.

12. The AR glasses of claim 1, further comprising a localization unit to apply simultaneous localization and mapping (SLAM) algorithms to map a near-field environment surrounding the user.

13. The AR glasses of claim 1, further comprising a virtual reality (VR) unit to generate one or more virtual objects to be displayed on the see-through display.

14. The AR glasses of claim 13, wherein the virtual objects comprise one or more of:
environmental information;
a virtual golf coach;
golf swing recommendations; and
golf performance data.

15. The AR glasses of claim 1, further comprising a power unit.

16. A computer system, comprising:
a processor; and
a storage device coupled to the processor, wherein the storage device stores instructions which, when executed by the processor, cause the processor to perform a method for assisting a user in playing golf, the method comprising:
obtaining, by a number of sensors embedded in a pair of augmented reality (AR) glasses worn by the user, environmental information associated with a golf course;
displaying, by a see-through display associated with the AR glasses, the environmental information;
generating and displaying a game plan for striking a golf ball toward a destination;
monitoring simulated golf swings performed by the user;
generating and displaying golf swing recommendations; and
displaying performance data associated with the user's striking of the golf ball.

17. The computer system of claim 16, wherein the see-through display comprises a near-eye geometric-waveguide-based display or a near-eye holographic-waveguide-based display.

18. The computer system of claim 16, wherein the sensors comprise one or more of:
a number of front-facing cameras;
a number of rear-facing cameras;
a sound sensor;
a number of motion sensors; and
a Global Positioning System (GPS) sensor.

19. The computer system of claim 16, wherein monitoring the simulated golf swings comprises communicating with a golf launch monitor and/or one or more wearable sensors via a Bluetooth communication unit embedded in the AR glasses.

20. The computer system of claim 16, wherein the game plan comprises one or more of:
a shot angle;
swing strength; and
a club recommendation.
